(19) United States
(12) Patent Application Publication
(10) Pub. No.: US 2005/0149263 A1
(43) Pub. Date: Jul. 7, 2005

(54) Red light visual inductive anti-collision system

(76) Inventor: Cho-Ki Chow, Surrey (CA)

Correspondence Address: CHO-KI CHOW, 16585 108th Ave, Surrey, BC, V4N 1N6, CA

(21) Appl. No.: 10/751,833

(22) Filed: Jan. 6, 2004

(51) Int. Cl. G01N 31/00

(52) U.S. Cl. 701/301

(57) ABSTRACT

I, Cho-Ki Chow, have invented a Red Light Visual Inductive Anti-collision System, as set forth in the following specification. The claimed system is used to assist drivers in controlling the vehicles under any weather conditions. In particular, it can warn the drunk drivers of the collision risk, cut off the engine fuel and reduce the speed before the accident happens. It also can prevent panic drivers from accelerating the vehicle by mistake so as to minimize the damages of the accident. The key component of the system is the digital data processing unit, which processes, distinguishes and compares data, and controls functional components of the system.

### REFERENCES CITED

| | | | |
|---|---|---|---|
| 5,818,332 | Oct. 6, 1998 | Yau Dang | 340/441 |
| 5,708,410 | Jan. 13, 1998 | Blank et al | 340/438 |
| 5,172,100 | Dec. 15, 1992 | Lino | 345/7 |

### BACKGROUND OF THE INVENTION

Safe driving is a top priority for all drivers. Traffic accidents lead to serious consequences. Red light visual inductive anti-collision system is invented in a bid to reduce traffic accidents or alleviate the consequences of traffic accidents. To address traffic problem, Yau Dang invented an automobile speed indicator using deferent light colors to indicate car speed. However, limited vision such as bad weather may prevent the drivers from noticing the warning signals. In addition, Dang's invention does not help drivers cut off the engine fuel and brake the cars.

### BRIEF SUMMARY OF THE INENTION

Red light visual inductive anti-collision system utilizes the technology of crystal chips to sense the distance between the two vehicles, and compare and interpret the acquired data with the preset base data to determine the appropriate actions to take. The system can assist drivers in controlling the vehicles under any weather conditions. Particularly, it can warn the drunk drivers of the collision risk, cut off the engine fuel and brake the motor vehicle to avoid or minimize the damages of the accident.

### BRIEF DESCRIPTION OF THE DRAWINGS

FIG. 1 shows a flowchart of red light visual inductive anti-collision system.

FIG. 2 shows a function structure thereof.

FIG. 3 demonstrates an installed location.

FIG. 4 shows a front view and a rear view of the digital data processing unit.

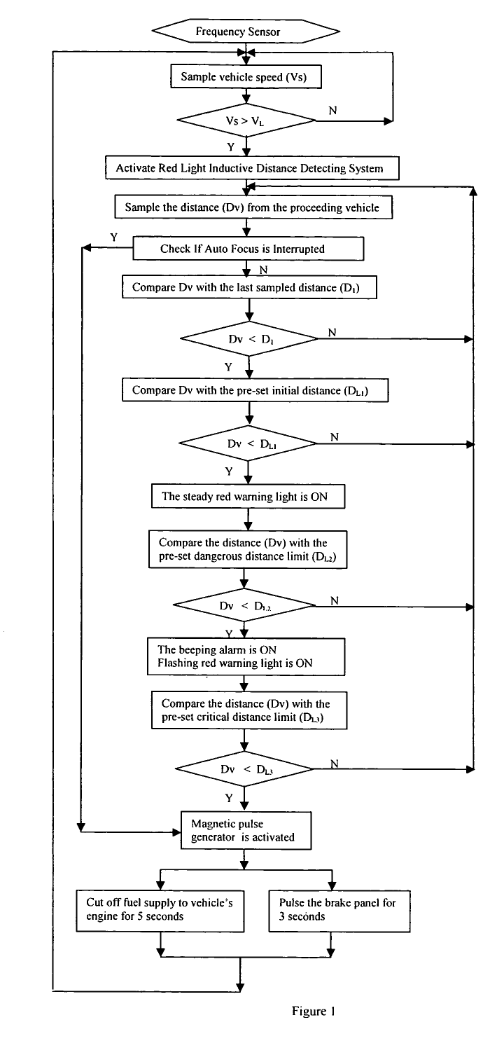

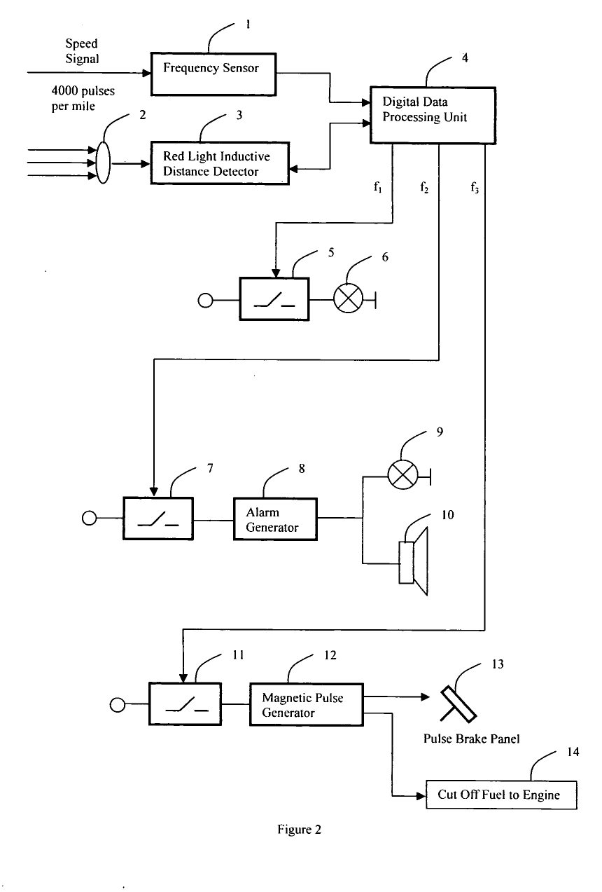

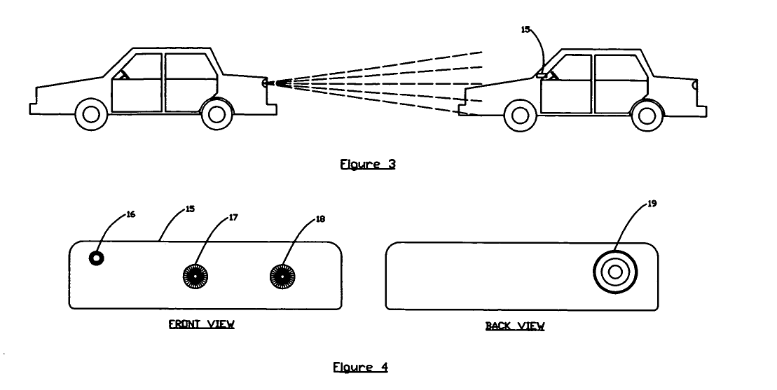

### DETAILED DESCRIPTION OF THE INVENTION

A frequency sensor 1 detects the speed of the vehicle and transfers data to the digital data processing unit (DDPU) 4. When the speed of the vehicle is over 60 km per hour, a command is sent from the DDPU 4 to activate the Red Light Visual Inductive Anti-Collision System. Red light inductive distance detector 3 receives data from the automatic focus lens 2 and sends the distance data from the proceeding car to the DDPU 4. If the automatic focus is interrupted, the DDPU 4 activates the magnetic shock generator 12, which will cut off and hold fuel supply 14 to the vehicle's engine for five seconds and pulse the brake panel 13 for three seconds. If the automatic focus is not interrupted, the DDPU 4 will compare the new distance data (Dv) with the last sampled distance data (D1). If the new distance (Dv) is greater than the last sampled distance (D1), the DDPU 4 continues to sample the distance from the preceding vehicle; or otherwise it compares the new distance (Dv) with the preset initial distance (DL1). If the new distance is greater than the preset initial distance, the DDPU 4 continues to sample the distance from the preceding vehicle; or otherwise the DDPU 4 turns on the red warning light 18. Then the DDPU 4 continues to compare the new distance with the preset dangerous distance limit (DL2). If the new distance is greater than the preset dangerous distance limit, the DDPU 4 continues to sample the distance from the preceding vehicle; or otherwise it turns on the buzzer 10 and flashing red warning light 9. Finally, the DDPU 4 compares the new distance with the preset critical distance limit (DL3). If the new distance is greater than the preset critical distance limit, the DDPU 4 continues to sample the distance from the preceding vehicle; or otherwise it activates the magnetic pulse generator 12 to cut off and hold fuel supply to the vehicle's engine for five seconds, and pulse the brake panel for three seconds. Then the Light Visual Inductive Anti-Collision System will be reset and the DDPU 4 repeats the above-noted action.

1) Red light visual induction processing technology
A. The specific distance between one vehicle and the preceding vehicle is taken and converted into computer data, which becomes base data in the storage and data processing unit.
B. The data acquired by the digital inductive detector from the preceding vehicle will be compared with the base data in the storage and data processing unit. When the data close to or below the base point, the anti-collision system will be activated through the induction effect.

2) Structural design of the red light visual inductive anti-collision system:
A. Base data storage and the digital data processing unit. It consists of two components: base data storage and digital data processing unit that compares the base data with the data just acquired.
B. Data inductive detector. When the inductive detector acquires the data from the preceding vehicle, it sends the data to the base data storage and data processing unit which processes, distinguishes and compares these data. If certain conditions are met, the anti-collision system will be activated through the induction effect.
C. The base data storage and data processing unit start working after they directly receive the data acquired by the detector. The data processing unit controls three components: signal warning component—warning light and buzzer, and the other two functional components. The functional components magnetically cut off fuel to the engine, and control the brake shock device.
D. The data storage and data processing unit localize the previous vehicle by straight-line focusing with the preset speed over 60 km per hour. The anti-collision system starts operating when the vehicle is within 30 meters to the previous vehicle.
